(19) United States
(12) Patent Application Publication
(10) Pub. No.: US 2015/0278485 A1
(43) Pub. Date: Oct. 1, 2015

(54) DESIGNING COMBINATIONS THERAPIES OF NON-INTERACTING DRUGS FOR EVOLUTIONARY DYNAMICS OF DISEASE USING OPTIMAL CONTROL

(71) Applicants: CALIFORNIA INSTITUTE OF TECHNOLOGY, Pasadena, CA (US); LUND UNIVERSITY, Lund (SE)

(72) Inventors: Vanessa JONSSON, PASADENA, CA (US); Nikolai MATNI, PASADENA, CA (US); Anders RANTZER, LUND (SE); Bo Bernhardsson, Lund (SE)

(21) Appl. No.: 14/672,002

(22) Filed: Mar. 27, 2015

Related U.S. Application Data
(60) Provisional application No. 61/971,634, filed on Mar. 28, 2014.
(60) Provisional application No. 62/108,949, filed on Jan. 28, 2015.

(51) Int. Cl. G06F 19/00; G06F 19/18

(52) U.S. Cl. CPC G06F 19/706; G06F 19/18

(57) ABSTRACT

A method of generating a combination therapy model for treating HIV is described. The method includes receiving a group of selected antibodies for the treatment of HIV and fitness parameters for a number of escape mutants and utilizing an iterative algorithm to determine suboptimal or optimal combinations of antibodies and concentrations for each selected antibody. The algorithm explicitly accounts for evolutionary dynamics of a generic disease.

### CROSS-REFERENCE TO RELATED APPLICATIONS

The present application claims priority to U.S. Patent Application No. 61/971,634 filed on Mar. 28, 2014 and U.S. Patent Application No. 62/108,949 filed on Jan. 28, 2015, the disclosures of which are incorporated herein by reference in their entirety.

### STATEMENT OF GOVERNMENT GRANT

This invention was made with government support under W911NF-09-D-0001 awarded by the Army Research Office. The government has certain rights in the invention.

### BACKGROUND

A challenge inherent to the treatment of certain infectious and non-infectious diseases, such as HIV or cancer, is the risk that the pathogen or tumor will evolve away and become resistant to treatment methods that comprise the standard of care. Especially vulnerable to this phenomenon are treatment methods that involve exposing the disease population (such as viruses or cancer cells) to single therapies for an extended period of time. In particular, this establishes an environment in which the occurrence of mildly drug resistant pathogens or tumor cells can develop a huge evolutionary advantage over the pathogenstumor cells for which the monotherapy is targeted, leading to so called “treatment-escape”. This phenomenon has received considerable attention in the biology and biomedical communities. For example, the human immunodeficiency virus (HIV) has been shown to escape from anti-HIV monotherapies, whether they are a small molecule drug or an antibody. In cancer treatment, acquired tumor resistance arises with targeted drugs and cytotoxic chemotherapy, limiting their utility and requiring design of alternative drugs for resistant tumors. One of the solutions that has been proposed is the rational design of combination therapy, much in the spirit of highly active antiretroviral therapy (HAART), which is the current standard of care for the treatment of HIV. See, for example, B. Al-Lazikani, U. Banerji, and P. Workman's “Combinatorial drug therapy for cancer in the post-genomic era,” Nature Biotechnology, Vol. 30, pp. 679-692, July 2012, and D. Lane's “Designer combination therapy for cancer,” Nature Biotechnology, Vol. 24, pp. 163-164, 2006.

Recent results by Rosenbloom et al. (see D. I. S. Rosenbloom, A. L. Hill, S. A. Rabi, R. F. Siliciano, and M. A. Nowak's “Antiretroviral dynamics determines HIV evolution and predicts therapy outcome,” Nature Biotechnology, Vol. 18, pp. 1378-1385, June 2012) have been more quantitative in nature, modeling the evolutionary dynamics of HIV and showing through simulations how the effect of antiretroviral dynamics can determine HIV evolution and therapy outcome. The Michor lab showed the effects of different erlotinib dosing strategies in the presence of pharmacokinetic fluctuations on the evolution of resistance of non-small cell lung cancer through simulations of a stochastic evolutionary dynamics model (see F. Michor, Y. Iwasa, and M. A. Nowak's “Dynamics of cancer progression,” Nature Reviews Cancer, Vol. 4, No. 3, pp. 197-205, 2004).

Although these methods have provided some insight into the problem, the challenge of designing treatment protocols that prevent escape was still an issue.

### SUMMARY

Described herein are methods for creating targeted combination drug therapies by utilizing feedback strategies that stabilize the evolutionary dynamics of the generic disease model.

According to a first aspect, a method for creating a combinational drug therapy for HIV is described, comprising: selecting a plurality of drugs, each of the plurality of drugs comprising at least one HIV escape mutant neutralizing antibody; determining replication rates and degradation rates of a plurality of escape mutants of the HIV; determining neutralization characteristics of each of the plurality of drugs; creating an evolutionary dynamics model of the HIV based at least on the replication rates, the degradation rates, and the neutralization characteristics; calculating dosages of each of the plurality of drugs using an iterative algorithm based on the evolutionary dynamics model, the algorithm including a Hill equation, wherein the dosages are non-negative real values; and creating a combinational drug therapy based on the dosages.

### BRIEF DESCRIPTION OF DRAWINGS

FIG. 1A shows the sum of virus populations over time for the nominal closed loop controller (solid line) and for random time invariant perturbations in the dynamics with the same controller (dashed lines).

FIG. 1B shows the sum of virus populations over time for the robust closed loop controller (solid line) and for random time invariant perturbations in the dynamics with the same controller (dashed line).

FIG. 2A shows the sum of virus populations subject to random time invariant perturbations of 5% in the dynamics for 30 different simulations for a stabilizing closed loop controller comprised of antibody pentamix (0.4687, 0.7815, 0.6129, 0.6279, 0.8831) μg/mol of (3BC176, PG16, 4546G54W, PGT128, 10-1074) synthesized using the convex program.

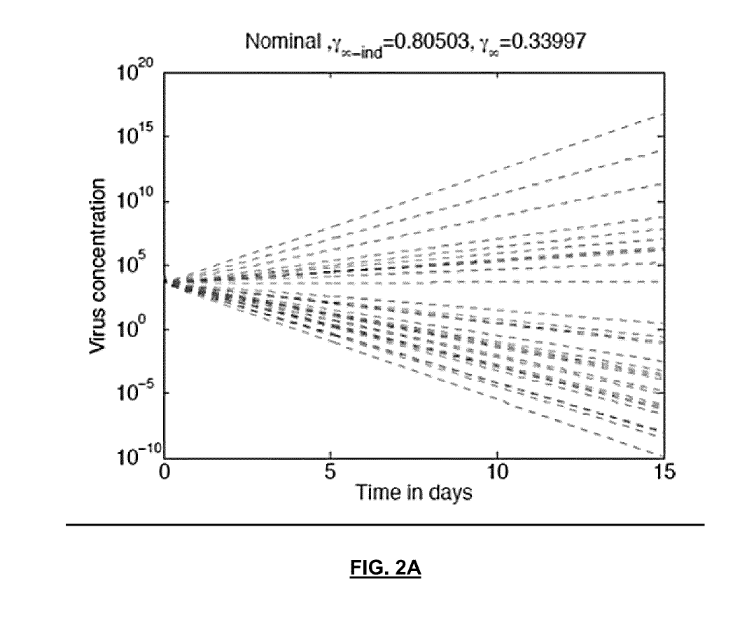

FIG. 2B shows the sum of virus populations subject to random time invariant perturbations of 5% in the dynamics for 30 different simulations for a robustly stabilizing closed loop controller comprised of antibody trimix (0.6891, 0.6712, 1.0706) μg/ml of (3BC176, 4546-G54W, PGT128) synthesized using the [symbol] ₁ combination therapy algorithm.

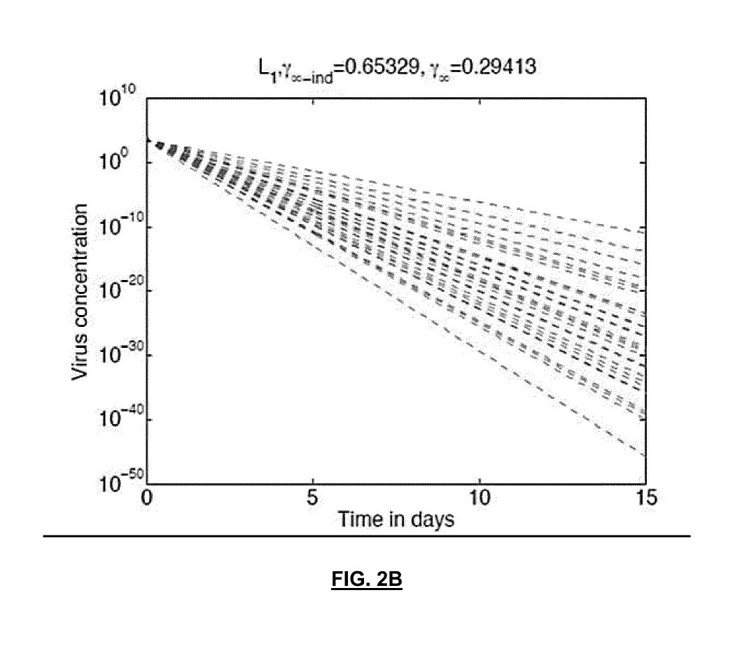

FIG. 3A shows piecewise linear approximation (dashed line) of the Hill function (solid line) for PG16-wild type clade B YU2 HIV-1.

FIG. 3B shows the robustness versus number of sparse controllers synthesized using the [symbol] ₁ nonlinear combination therapy algorithm for the first lexicographically ordered twenty robustly stable sparse modes. Two different 3-sparse antibody trimixes are synthesized, with the dominant trimix being the one that excludes PG16.

FIG. 4 shows a method for utilizing the combination therapy algorithms in creating combination drug treatments for a patent having HIV.

### DETAILED DESCRIPTION

### Population Dynamics Model

The vector of mutant i can be represented by the quasispecies model of Equation 1:

\dot{x}ᵢ=(rᵢqᵢᵢ−dᵢ)xᵢ+Σ_{k≠i}ⁿrᵢqₖᵢxₖ−Σₐ₌₁^{m} [symbol] ₐᵢlₐxᵢ (eq. 1)

where xᵢ is the concentration of mutant i out of a set of n mutations, lₐ is a concentration of neutralizing macromolecules a (assumed to remain at a constant concentrations throughout) out of a set of m macromolecules, rᵢ, and dᵢ, are the replication and degradation rates of mutant i, qₖᵢ, is the probability that a non-i mutant (a k mutant) mutates into mutant i, and qᵢᵢ is the probability that mutant i does not mutate. z,60 ₐᵢ(lₐ) is a Hill function of the association constant K for each neutralization reaction generally quantifying the fraction of bound receptors (e.g. cell receptor, virus proteins) as a function of neutralizing macromolecule l (e.g. drug, ligand, antibody) concentration reactions for the binding reaction:

$$\begin{matrix}{𝓁}_{a} + ρ {\to }^{{K}_{A}} {𝓁}_{a} \cdot ρ & ( eq . 2 ) \\ {ψ}_{ρ} ( {𝓁}_{a} ) = \frac{{[ {𝓁}_{a} ]}^{{n}_{a}}}{{[ {𝓁}_{a} ]}^{{n}_{a}} + {K}_{a}^{{n}_{a}}} & ( eq . 3 )\end{matrix}$$

where Kₐ

$$( i . e . \frac{1}{{K}_{A}} )$$

is the dissociation constant associated with the binding reaction and nₐ is the Hill coefficient which represents the degree of cooperativity (i.e. the degree to which a binding of a ligand molecule modulates the probability of another ligand molecule binding).

The first term of the quasispecies model, (rᵢqᵢᵢ−dᵢ)xᵢ, provides for the replication of the mutant i. The second term of the model, Σ_{k≠i}ⁿrᵢqₖᵢxₖ, provides for the mutation of the mutant i into non-i mutants. The third term of the model, Σₖ₌₁^{m} [symbol] ₖᵢlₖxᵢ, provides for the neutralization of the mutant i by neutralizing macromolecules. The third term is provided as a non-competitive drug binding model, where the effect of each drug is roughly additive.

Given the model for a pathogen, such as HIV, the goal is to design a combination drug therapy where the disease dynamics are stable, the controlled system is robust against uncertainty, the number of types of drugs (neutralizing macromolecules) used in the combination is minimized, and the concentrations of each of the drugs is minimized. The design should be scalable for large numbers of mutants (n in Equation 1) andor for many types of drugs (m in Equation 1).

### Problem Formulation

The model of Equation 1 can be represented by the following state space representation:

\dot{x}=(A−ΨL)x+w (eq. 4)

z=Cx (eq. 5)

with A being a Metzler matrix where Aᵢⱼ=rᵢqᵢⱼ (i≠j) and Aᵢᵢ=rᵢqᵢᵢ−dᵢ, Ψ is a block diagonal matrix [symbol] ^{mn×n} with diagonal elements that describe the fitness of n mutants with respect to m different neutralizing macromolecules, L=(I [symbol] l), l is a block diagonal matrix that encodes the concentrations of neutralizing macromolecules for all n mutants, C is Ψ 1̅0̅5̅ L, and w is an arbitrary positive disturbance.

### Suboptimal Combination Therapy _{∞} Algorithm

An [symbol] _{∞} approach (treating the therapy design as a [symbol] _{∞} state feedback synthesis problem) can provide a principled design of targeted combination therapy concentrations that explicitly account for inherent evolutionary dynamics.

[symbol] _{∞} describes the space of matrix-valued functions that are both analytic and bounded in the open right-half of the complex plane defined by Re(s)>0. The [symbol] _{∞} norm is the maximum singular value of the function over that space.

Setting the regulated output z=1 ₙX to be the total virus population provides that the resulting treatment plan will drive the total mutant population to zero. Taking G to denote a closed loop system of Equations 4 and 5, neutralizing macromolecule concentrations l can be reverse engineered by finding a Ψ(l) that leads to a stable G satisfying ∥G∥_{∞-ind}<γ, where γis a robustness level (γₛfor a stabilizing controller and γᵣfor a robust controller).

### Stabilizing Controller

A simple algorithm for the synthesis of a stabilizing controller for the nominal system, which admits a particularly simple formulation in light of the Metzler nature of A is provided. There exists ε>0 such that the solution to the convex program:

minimize l

subject to

A_{d}+εI−ΨL<0 (eq. 6)

L=I [symbol] l

is a stabilizing controller for the system, where A_{d} is a diagonal matrix comprised of the diagonal elements of A.

B) [symbol] _{∞} Controller

Given the Metzler nature of A, a simple non-convex program (Equation 7) can be derived taking the closed loop (A_{cl}):

$$minimize γ \\ subject to \\ [ \begin{matrix}{A}_{cl}^{T} X + {XA}_{cl} + {( \overline{Ψ} L )}^{T} ( \overline{Ψ} L ) & X \\ X & - {γ}^{2} I\end{matrix} ] ≺ 0 \\ {A}_{cl} = ( A - Ψ L ) \\ L = I ⊗ 𝓁 \\ X ≻ 0 , X diagonal \qquad ( eq . 7 )$$

Letting program P_{x′}(l,γ) denote solving Equation 6 with X=X′ fixed and optimizing over l and γ, and letting program P_{l′}(X, γ) denote solving Equation 7 with l=l′fixed and optimizing over X and γ, and letting (Z, γ)=P_{z′}(Z, γ) denote the solutions to the respective programs for Z, Z′ ∈ {X, l}, an algorithm for combination therapy can be presented by:

Set ε>0

Solve Equation 6 to obtain an initial stabilizing controller l′ (γ=γₛ)

while γ′−γ>ε:
Set (X′, γ)=P^{l′(X, γ)}
Set (l, γ)=P_{x′}(l,γ)
Set γ′=γ

The iterative process of the non-convex algorithm is non increasing and bounded by zero, thereby implying convergence to a local minimum value of γ=γᵣ.

II Suboptimal Combination Therapy Scalable [symbol] ₁ Algorithm

Furthermore, an algorithm with greater scalability can be had by reformulating the combination therapy problem as a second order cone program (SOCP).

Given the state space representations of Equations 4 and 5, with output C modeled as C=[1ₙL^{T}]^{T}, the following iterative programs (Equations 8 and 9) can be utilized to find a stabilizing controller:

P1ₗ(X, γ): (eq. 8)

minimize x∥CX∥_{∞}

subject to

AX+ΨLX+l1<0

L=I [symbol] l

X>0

Set γ=∥CX*∥_{∞} where X* is the optimal solution to Equation 8

Set D=(X′, λ₁, λ₂,), where λ₁ and λ₂ are tuning parameters initialized at zero

P2_{D}(l, γ) (eq. 9)

minimize ₗ∥CX∥_{∞}+λ₁∥l∥₁+λ₂ ∥l∥₂

subject to

AX+ΨLX+I1<0

L=I [symbol] l

CX<γ

The scalable combination therapy algorithm can be provided by:

Set ε>0

Solve for initial stabilizing controller l′

Solve equation 6 for controller l0

minimize l∈ [symbol] ^{m}∥L∥_{∞}

subject to A_{d}+εI−ΨL<0 and L=I [symbol] l
Set (X′, γ)=P1ₗ₀(X, γ)
Set (l′, γ)=P2_{(x′,0,0}(l, γ)
Find (λ′₁, λ′₂, l) that minimize γ:
   ∀(λ₁,λ₂) ∈Λ₁×Λ₂
   while γ′−γ>ε:
      Set (X′, γ)=Pₗ′(X, γ)
      Set (l′, γ)=P_{x′}(l, γ)
      Set γ′=γ

The iterative process of the non-convex algorithm is non increasing and bounded by zero, thereby implying convergence to a local minimum value of γ=γᵣ.

### III. Suboptimal Combination Therapy 1 Algorithm for Non-Linear Pharmacodynamics

If there are synergistic or antagonistic drug combinations, or any other non-linear pharmacodynamics effects, then the Algorithm can be modified to take those effects into consideration.

The quasispecies model can be modified, as shown in Equation 10, to take into account the pharmodynamics Ψᵢ(l) of individual drugs l=(lₐ) and their combinations with respect to the i-th mutant species as shown in Equation 9.

\dot{x}ᵢ=(rᵢqᵢᵢ−dᵢ)xᵢ+Σ_{k≠i}ⁿrᵢqₖᵢxₖ−Ψᵢ(l)xᵢ (eq. 10)

The pharmacodynamics Ψᵢ(l) can be represented by the sum of non-linear drug effect functions, as represented by Hill equations.

When there is a large number of non-interacting or synergistic drug combinations, a piecewise linear approximation algorithm and a mode reduction algorithm can be used to take into account non-linear pharmacodynamics while reducing the search space of the algorithm. The approximated algorithm can be presented in a sparse mode reduction algorithm:

$$Let {𝓁}_{ω max} ∈ {ℝ}^{m} be the maximum possible drug concentration . \\ Set {𝓁}_{ω i ← } {𝓁}_{ω max} , γ > 0.$$

$$while ( {𝓁}_{ω i} == {0}_{n} ε ) : \\ if ‖ {G}_{{𝓁}_{ω i}} ‖ < γ , \\ S = S ⋃ {ω}_{i}$$

$$else$$

$$u = u ⋃ {ω}_{i}$$

$$Set {𝓁}_{ω i + 1} = \frac{{𝓁}_{ω i}}{2}$$

$$Set ε = ( {ω}_{i} ∈ S \vert \vert {ω}_{i} u )$$

Given the state space representations of Equations 4 and 5, with output C modeled as C=1ₙ^{T}, the following iterative programs (Equations 11 and 12) can be utilized to find a stabilizing controller:

P1_{l,ω}(x,s): (eq. 11)

minimize s, where x ∈ [symbol] ₊ⁿ, s

subject to:

A_{ω}x+Ψ_{ω}Lx+1≦s

L=I [symbol] l where l ∈ ω

1ₙ^{T}x≦γ

s<0, x≧0

P2_{(x, λ1,λ2,ω)}(l) (eq. 12)

minimize λ₁∥l∥₁+λ₂∥l ∥₂

subject to

A_{ω}x+Ψ_{ω}Lx+1<0

L=I [symbol] l where l ∈ ω

1ₙ^{T}x≦γ

where λ₁∥I∥₁ is the drug concentrations, λ₂∥I∥₂ is the number of drugs used, and s is a slack variable introduced to prevent immediate convergence to a local minimum.

Non-linear scalable combination therapy can be provided by:

Set l₀=l_{ωmax}

Check if P1_{l0,ω}(x,s) is feasible. If feasible:
Set (x′, s′)=P1_{l0,ω}(x,s)
Set (l′)=P2_{(x′,0,0 ω)}, (l)

else, move to next mode and return to step 1.

Find (λ′₁, λ′₂, l_{ω}) for mode ω:
∀(λ₁,λ₂) ∈Λ₁×Λ₂
Set s=1
while [symbol] (s′==s):
   Set s=s′
   Set (x′,s′)=P1_{l′,ω}(x,s)
   Set (l′)=P2_{(x′,λ1,λ2,ω)}(l)

### III. Optimal Combination Therapy Convex-Monotone Algorithm

Given a Metzler matrix A, let the mutant concentration function x(t) be the solution of:

\dot{x}(t)=(A+Σᵢ₌₁^{m}uᵢ(t)Dⁱ)x(t), x(0)=a>0 (eq. 13)

where the Dⁱ are diagonal matrices, uᵢ(t) are time-varying drug doses of a set of m drugs, A=δI+μM, δ is the clearance rate, μ is the viral mutation rate, and M is a mutation matrix where an element mₖⱼ of M models the mutation rate from mutant j to mutant k. Then log xₖ(t) is a convex function of (a, u).

With constant uₖ and if the initial state is not taken into account, an alternative problem focusing on asymptotic growth rate can be formulated as selection of uᵢ that minimize the Perron-Frobenius eigenvalue λ_{PF} of the matrix A+ΣᵢuᵢDⁱ. This can be done by convex optimization.

By exploiting the monotonicity of the system, optimal control problems for certain nonlinear dynamical systems, with right-hand sides described by convex functions, can be stated in terms of convex optimization. The system is said to be monotone if the solution is a monotone function of the initial state a and the input trajectory u.

Let aₖⱼ be the entries of A, let Dₖⁱ be the kth diagonal element of Dⁱ, define zₖ as log xₖ. Then:

$${\dot{z}}_{k} ( t ) = \frac{{\dot{x}}_{k} ( t )}{{x}_{k} ( t )} = {\sum }_{kj} {a}_{kj} \frac{{x}_{j} ( t )}{{x}_{k} ( t )} + {\sum }_{i} {u}_{i} ( t ) {D}_{k}^{i}$$

$${\dot{z}}_{k} ( t ) = {\sum }_{kj} {a}_{kj} exp ( {z}_{j} - {z}_{k} ) + {\sum }_{i} {u}_{i} ( t ) {D}_{k}^{i}$$

is a convex monotone system since aₖⱼ≧0 when k≠j and A is a Metzler matrix.

Given an initial virus population at t=0, the total amount of virus at time t=T is a convex function of uᵢ, . . . , uₘ, on the time interval [0,T]. Hence, an optimal time-varying treatment can be found by convex optimization.

### EXAMPLES

### Example 1

### HIV/Antibody Therapy Application of _{∞} Algorithm

Described in this example is an approach to the design of antibody treatments for chronic infection with human immunodeficiency virus-1 (HIV-1) using the non-convex [symbol] _{∞} algorithm. This example is in connection with the experimental results of evolutionary dynamics of HIV-1 in the presence of antibody therapy obtained in reference [1], which is incorporated herein by reference in its entirety. The experiments described in this example show that a combinational therapy approach using the non-convex [symbol] _{∞} algorithm results in a controller with robustness properties.

A relatively recent discovery is that a minority of HIV infected individuals can produce broadly neutralizing antibodies (bNAbs), that is, antibodies that inhibit infection by many strains of HIV [12]. Recent experimental results, conducted by Florian Klein et al. in the Nusswenzeig lab at Rockefeller University, have demonstrated that the use of single antibody treatments can exert selective pressure on the virus, but escape mutants, due to a single point mutation, can emerge within a short period of time [14]. Although antibody monotherapy did not prove effective, it was shown that equal, high concentrations of an antibody pentamix effectively control HIV infection and suppress viral load to levels below detection. One aspect of this example is to demonstrate how the non-convex algorithm offers an approach to design combination antibody therapies that control HIV infection and prevent evolution of any set of known resistant mutants. In a realistic setting, the ability to do this relies on the knowledge of what resistant viruses may be selected for with single therapies, and so this algorithm would be most effective in conjunction with single antibody selection experiments.

(1) Model Parameters:

A system of eighteen HIV mutants with five potential antibodies in combination is used. Table 1 lists the mutants considered in this example with their corresponding half maximal inhibitory antibody concentration (IC50) in μg/ml, as measured by the Nussenzweig lab in [14].

In Table 1, WT signifies the “wild type” YU2 laboratory strain of Glade B replication competent HIV. Mutations are labeled by the amino acid occurring in the WT strain, followed by the location of the amino acid and the amino acid mutation. For example, in mutant G471 R, Gly (G) at position 471 in the WT is mutated into Arg (R). Each mutation was found by doing a selection experiment: a humanized mouse was infected with monoclonal YU2 strain and given continuous mono therapy of either 3BC176, PG16, 45-46G54W, PGT128, or 10-1074. Mutant resistant viruses emerged as a result of these selection experiments and IC50s values were measured. Antibodies 3BC176, PG16, 45-46G54W, PGT128 and 10-1074 are potential combination therapy candidates.

TABLE 1
IC50 values for the indicated antibodies for mutant viruses found in
continuous antibody monotherapy experiments conducted by the
Nussenzweig lab at Rockefeller University [14].

| | 3BC176 | PG16 | 45-46G54W | PGT128 | 10-1074 |
|---|---|---|---|---|---|
| Mutation | IC50 μg/ml | IC50 μg/ml | IC50 μg/ml | IC50 μg/ml | IC50 μg/ml |
| WT | 0.319 | 0.612 | 0.024 | 0.169 | 0.312 |
| G471R | 0.159 | 0.154 | 0.008 | 0.02 | 0.091 |
| N160K | 0.145 | 50 | 0.007 | 0.086 | 0.155 |
| T162N | 0.154 | 50 | 0.013 | 0.166 | 0.175 |
| N279H | 0.209 | 0.294 | 50 | 0.064 | 0.177 |
| N280Y | 0.276 | 0.145 | 50 | 0.031 | 0.126 |
| N332K | 0.232 | 0.988 | 0.017 | 50 | 50 |
| N332Y | 0.269 | 0.632 | 0.01 | 50 | 13.596 |
| S334N | 0.218 | 0.615 | 0.02 | 50 | 7.308 |
| Y61H | 0.243 | 0.285 | 0.015 | 0.098 | 0.26 |
| E102K | 0.173 | 0.341 | 0.023 | 0.11 | 0.207 |
| N295S | 0.347 | 0.5 | 0.017 | 0.145 | 0.159 |
| I311M | 0.23 | 2.67 | 0.013 | 0.248 | 0.253 |
| S365L | 0.26 | 0.273 | 0.009 | 0.045 | 0.153 |
| G366E | 0.187 | 0.167 | 0.001 | 0.021 | 0.074 |
| I371M | 0.2 | 0.303 | 0.013 | 0.064 | 0.164 |
| N413K | 0.188 | 0.557 | 0.014 | 0.032 | 0.109 |
| E429K | 0.146 | 0.503 | 0.017 | 0.082 | 0.167 |

It is noted that virus replication rates can vary depending on the nature of the mutations a virus may undergo. In this example, a replication rate of 0.5 (ml*day)⁻¹ for all mutants was chosen. The selection is justified by noting that escape mutants grew to be dominant mutants during selection experiments and assume that replication rate variability due to mutations were negligible.

The fitness function associated with the neutralization of a virus i with respect to an antibody j is a Hill function

$${ψ}_{ij} = \frac{{l}_{j}^{n}}{{l}_{j}^{n} + {K}_{ij}^{n}}$$

where n is the Hill coefficient, lⱼ is the concentration of a given antibody j, and

$${K}_{ij} = \frac{{k}_{on}}{{k}_{off}} = \frac{[ {x}_{i} {l}_{j} ]}{[ {x}_{i} ] [ {l}_{j} ]}$$

is the association constant for the virus/antibody binding reaction lⱼ+xᵢ→kₒₙlⱼ·xᵢ, and kon and koff are the on and off reaction rate constants. Note that the association constant represents the fraction bound of antibody/virus complexes in solution and that

$${K}_{ij} = \frac{3 \cdot IC {50}_{ij}}{3 {r}_{i} + ln ( 2 ) - IC {50}_{ij}} ,$$

is found by solving Equation 1 for one virusantibody pair for the duration [t₀,t_{f}]=[0,3]. In this example, the Hill function is simplified by setting the Hill coefficient n=1, as there is evidence showing that antibodies do not bind cooperatively. The [symbol] _{∞} Algorithm yields antibody concentrations near zero, which yields the linear approximation

$${ψ}_{ij} = \frac{1}{{k}_{ij}} {𝓁}_{ij} .$$

In addition, the antibodies considered in this example do not target the same epitope. In other words, the antibodies do not bind competitively to the same sites on the virus, thereby reducing any coupling between antibody concentrations.

The mutation rate for HIV reverse transcriptase is μ=3×10-5 mutations/nucleotide base pair/replication cycle, and the HIV replication cycle is approximately 2.6 days. The rate of mutation for a particular amino acid mutation at a particular location is approximated to be

$$\frac{1}{{n}_{a}} {μ ( 1 - μ )}^{k} = 1.443 \times {10}^{- 6} per replication cycle ,$$

where k≈3000 is the size of the genome in residues and nₐ =19 is the number of amino acids that can be mutated to. Back mutations, which are mutations from mutants back to the wild type, are not considered as the probability of such mutation is negligible.

Units of concentration in number of virusesml or number of antibodies/ml are used for states, and time is measured in days. The standard volume is 1 ml.

### (2) _{∞} Controller

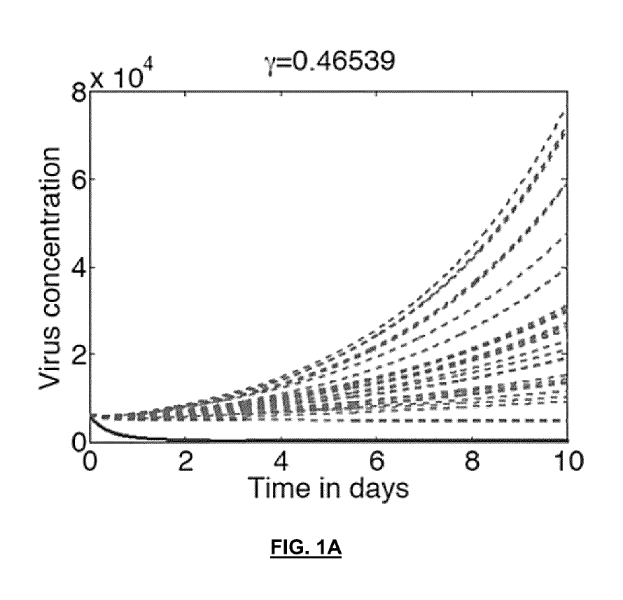

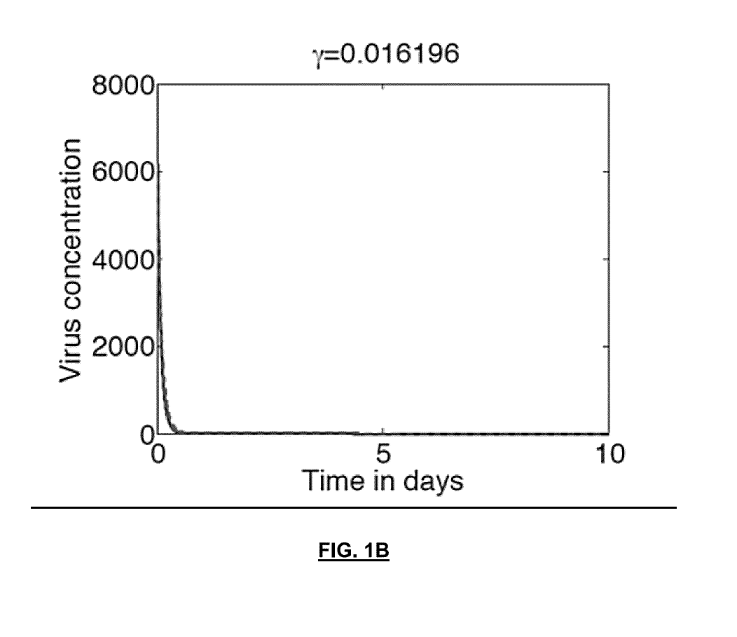

A nominal stabilizing controller, according to Equation 6, was synthesized. The stabilizing antibody concentration Lₛ={0.0125, 0.0125,0.0125,0.0125,0.0125} in μg/ml for antibodies {3BC176, PG16, 45-46G54W, PGT128, 10-1074} was found. Using the [symbol] _{∞} Algorithm with antibody constraints L≦1 μg/ml, a robust controller yielding antibody concentrations of Lᵣ={1, 0, 0.003, 0.0031, 0.0026} was synthesized. The closed loop [symbol] _{∞} norm of the stabilizing controller was found to be γₛ=0.4, whereas that of the synthesized robust controller had a norm of γᵣ=0.016. The simulations in FIG. 1 illustrate the need for robustness in the face of model uncertainty. The robust controller remains stabilizing in the presence of small additive model uncertainty in the mutation and replication parameters of the system, in comparison with the nominal stable controller. Note that the non-convex [symbol] _{∞} algorithm converged to this robust controller after nine iterations in 38.514 seconds.

### Example 2

### Synthesis of ᵢ Controller and its Application to HIV

A normal stabilizing controller using Equation 6 and a robust controller using Equation 13 are synthesized. The nominal stabilizing controller comprised of an antibody pentamix {0.4686, 0.7815, 0.6129, 06279, 0.0031} μg/mol of {3BC176, PG16, 45-46G54W, PGT128, 10-1074}, the same antibodies used in Example 1. The robust controller comprised an antibody trimax {0.6891, 0.6712, 1.0706} μg/mol of {3BC176, 45-46G54W, PGT128}. These two controllers were generated for the evolutionary dynamics of the full, thirty five HIV mutants listed in Table 2.

$$minimize γ + {λ}_{1} {‖ 𝓁 ‖}_{1} + {λ}_{2} {‖ 𝓁 ‖}_{2} \\ subject to \\ [ \begin{matrix}{A}_{cl}^{T} X + {XA}_{cl} + {C}^{T} C & X \\ X & - {γ}^{2} I\end{matrix} ] ≺ 0 \\ {A}_{cl} = ( A - Ψ L ) \\ C = {[ {1}^{T} {L}^{T} ]}^{T} \\ L = I ⊗ 𝓁 \\ X ≻ 0 , X diagonal \qquad ( eq . 13 )$$

Table 2 shows IC50 values for the indicated antibodies on YU2 mutant viruses found in continuous antibody mono therapy experiments conducted by the Nussenzweig lab at Rockefeller University. The trimix of antibodies includes 3BC176, 45-46G54W and PGT128 and the pentamix includes 3BC176, PG16, 45-46G54W, PGT128, 10-1074. Estimated two point mutations represent intermediary mutations needed for the model but not included in experimental results shown in reference [1]. The IC50 values were taken to be the maximum IC50 of both mutations.

TABLE 2
IC50 values for the indicated antibodies on YU2 mutant viruses found in
continuous antibody mono therapy experiments conducted by the Nussenzweig lab at
Rockefeller University [14].

| Antibody | | | | | | |
|---|---|---|---|---|---|---|
| associated | | | | 45- | PGT128 | 10-1074 |
| escape | | 3BC176 | PG16 | 46G54W | IC50 | IC50 |
| mutants | Mutation | IC50 μg/ml | IC50 μg/ml | IC50 μg/ml | μg/ml | μg/ml |
| | WT | 0.319 | 0.612 | 0.024 | 0.169 | 0.312 |
| 3BC176 | G471R | 0.159 | 0.154 | 0.008 | 0.02 | 0.091 |
| PG16 | N160K | 0.145 | 50 | 0.007 | 0.086 | 0.155 |
| | T162N | 0.154 | 50 | 0.013 | 0.166 | 0.175 |
| 45-46G54W | N279H | 0.209 | 0.294 | 50 | 0.064 | 0.177 |
| | N280Y | 0.276 | 0.145 | 50 | 0.031 | 0.126 |
| PGT128 or | N332K | 0.232 | 0.988 | 0.017 | 50 | 50 |
| 10-1074 | N332Y | 0.269 | 0.632 | 0.01 | 50 | 13.596 |
| | S334N | 0.218 | 0.615 | 0.02 | 50 | 7.308 |
| Passenger | Y61H | 0.243 | 0.285 | 0.015 | 0.098 | 0.26 |
| mutations | E102K | 0.173 | 0.341 | 0.023 | 0.11 | 0.207 |
| | N295S | 0.347 | 0.5 | 0.017 | 0.145 | 0.159 |
| | I311M | 0.23 | 2.67 | 0.013 | 0.248 | 0.253 |
| | S365L | 0.26 | 0.273 | 0.009 | 0.045 | 0.153 |
| | G366E | 0.187 | 0.167 | 0.001 | 0.021 | 0.074 |
| | I371M | 0.2 | 0.303 | 0.013 | 0.064 | 0.164 |
| | N413K | 0.188 | 0.557 | 0.014 | 0.032 | 0.109 |
| | E429K | 0.146 | 0.503 | 0.017 | 0.082 | 0.167 |
| | N295S-G366E- | 0.222 | 0.131 | 0.001 | 0.012 | 0.021 |
| | N413K | | | | | |
| tri-mix | T162I-G458D | 0.275 | 50 | 14.33 | 0.012 | 0.047 |
| | T162N-N280Y | 0.138 | 50 | 50 | 0.027 | 0.079 |
| penta-mix | N160K-N280Y- | 0.146 | 50 | 50 | 50 | 50 |
| | N332K | | | | | |
| | N160K-A281T- | 0.1 | 50 | 50 | 50 | 50 |
| | N332K | | | | | |
| | T162I-N280Y-N332K | 0.13 | 50 | 50 | 50 | 50 |
| | T162I-N279K- | 0.149 | 50 | 50 | 50 | 50 |
| | N332K | | | | | |
| Signature + | T162I-Y61H | 0.156 | 50 | 0.014 | 0.088 | 0.115 |
| Passenger | T162N-V430E | 0.167 | 50 | 0.003 | 0.037 | 0.106 |
| | N280Y-A174T | 0.064 | 0.138 | 50 | 0.01 | 0.021 |
| | N332S-N413K | 0.181 | 0.526 | 0.017 | 50 | 50 |
| Estimated | N160K-N280Y | 0.276 | 50 | 50 | 0.086 | 0.155 |
| Mutations | N160K-N332K | 0.232 | 50 | 0.017 | 50 | 50 |
| | N280Y-N332K | 0.276 | 0.988 | 50 | 50 | 50 |
| | N295S-G366E | 0.347 | 0.5 | 0.017 | 0.145 | 0.159 |
| | N295S-N413K | 0.347 | 0.557 | 0.017 | 0.145 | 0.159 |
| | G366E-N413K | 0.188 | 0.557 | 0.014 | 0.032 | 0.109 |

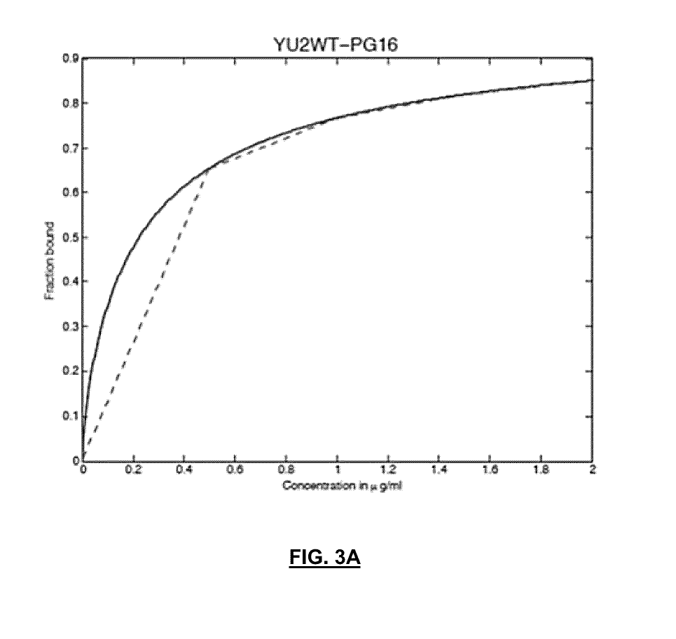

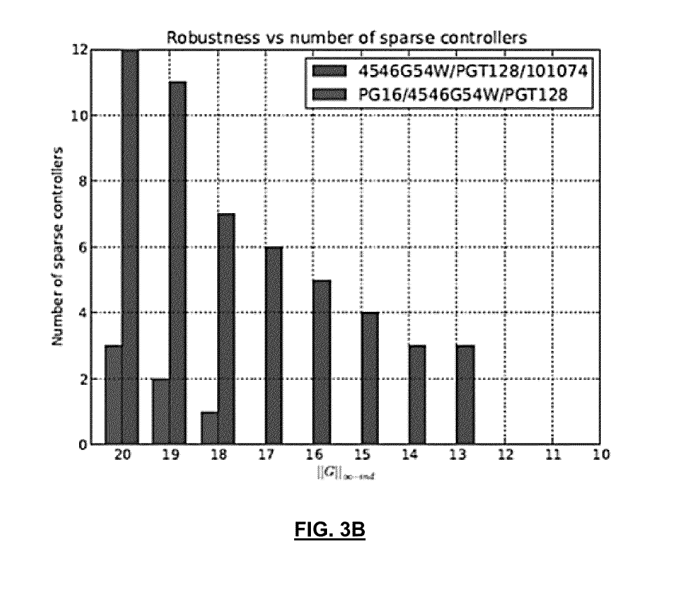

Both antibody pentamix (normal stabilizing) and trimix (robust) controllers have similar gains and appear to have comparable robustness properties. For some simulations of the closed loop dynamics subjected to 5% random time invariant perturbations in plant dynamics, the nominal controller is stabilizing, as seen in FIG. 3. This is qualitatively consistent with the experimental results done in by the Nussenzweig lab in reference [1]. With weekly injections of equal concentrations of the antibody pentamix holding concentrations constant has viral loads that remain below the limit of detection during an entire treatment course in mice.

In reference [1], an antibody trimix of equal concentrations of 3BC176, 45-46G54W and PGT128 was suggested and experimentally shown to produce a decline in the initial viral load. However, a majority of mice in the experimental study had a viral rebound to pre-treatment levels, suggesting that in these cases, the virus had evolved mutations that were resistant to the trimix treatment.

To compare the performance of the [symbol] ₁ synthesized controller with gains of {0.6891, 0.6712, 1.0706} μg/mol of {3BC176, 45-46G54W, PGT128} to the experimentally studied trimix, equal concentrations of {3BC176, 45-46G54W, PGT128}, namely {1, 1, 1} μg/ml for the experimentally derived trimix was chosen. It was found that even though total antibody concentrations were larger in the trimix used herein in comparison with the total concentration in the Nussenzweig's experiment, the robustly stabilizing controller synthesized by the [symbol] ₁ algorithm nonetheless performed overall better. The closed loop norms were ∥G∥_{∞}=0.2941 and ∥G∥_{∞-ind}=0.6533 for the [symbol] ₁ controller versus ∥G∥_{∞}=0.26433 and ∥G∥_{∞-ind}=0.74572 for the experimental trimix.

The results of this example demonstrate that the combination therapy perform well when design parameters such as sparsity, limits on the magnitude of gains, and robustness guarantees are simultaneously considered in the stabilizing solutions to the combination therapy. Experimentally searching for these combinations is infeasible as the number of potential therapies and possible concentrations to consider in experiments is intractable. The ability to design and synthesize combination therapy controllers as described in the examples can be used to guide these experimental activities. As such, a family of controllers can be generated based on “design specifications” tailored to not only the viral or cellular composition of the disease, but to explore tradeoffs between number of therapies used (sparsity), therapy concentrations (magnitude of the gain) and ability to support pharmacokinetic fluctuations (robustness to perturbations) and subsequently verify these experimentally.

### Example 3

### Applications to Additive Pharmacodynamics Binding Models

Described in this example is an approach to the design of antibody treatments for chronic infection with HIV-1 in light of the nonlinear pharmacodynamics and saturation concerns associated with antibody neutralization of HIV-1. This example is also in connection with the experimental results of evolutionary dynamics of HIV-1 in the presence of antibody therapy obtained in reference [1].

One aspect of this example is to demonstrate how the algorithm described herein offers an approach to design combination antibody therapies that control HIV infection and prevent evolution of any set of known resistant mutants given the nonlinear pharmacodynamics of antibody neutralization of HIV-1. The application of the algorithm relies on the knowledge of what resistant viruses may be selected for with single therapies and knowledge of antibody pharmacodynamics. The algorithms described herein would be most effective in conjunction with single antibody selection experiments and knowledge of antibody Hill function properties.

### (1) Model Parameters

Five potential antibodies in combination are used on an evolutionary dynamics model of twenty one mutants.

The Hill function associated with the fitness of a virus with respect to neutralization by an antibody is described in Equation 3. The Hill function parameters experimentally derived in reference [2] for antibodies 45-46G54W, PGT128 and PG16 and approximated for antibody 101074 were used in this example. The IC50 values of the mutants were taken from the list shown in Table 2.

The replication rates were selected to be 0.5 (ml·day)⁻¹ for all mutants. This selection is justified by noting that escape mutants grew to be dominant mutants during selection experiments and assuming that replication rate variability due to mutations are negligible. The mutation rate for HIV reverse transcriptase is μ=3×10⁻⁵ mutationsnucleotide base pairreplication cycle and the HIV replication cycle is approximately 2.6 days. The rate of mutation for a particular amino acid mutation at a particular location was approximated to be

$$\frac{1}{{n}_{a}} {μ ( 1 - μ )}^{k} = 1.443 \times {10}^{- 6} per replication cycle ,$$

where k≈3000 is the size of the genome in residues and nₐ=19 is the number of amino acids that can be mutated to. The model described herein supports forward point mutations and two point mutations. Back mutations are not considered in this model, as the probability of back mutation is negligible.

Units of concentration in number of viruses/ml or number of antibodies/ml are used for states, and time is measured in days. The standard volume is 1 ml.

(2) [symbol] ₁ Controller Synthesis

Ten piecewise linear approximations were performed on each of the Hill functions associated to each of the twenty one mutants and each of the four antibodies considered as possible candidate therapies, which generate 10000 possible pharmacodynamics modes to be searched over. Among the generated 10000 modes, 397 were found to be sparse and stable by a sparse mode reduction algorithm, which is a mode reduction algorithm for problems where there is a large number of non-interacting or synergistic drug combinations. The sparse mode reduction algorithm generates a set of modes that are 1) guaranteed to be stable and achieve a desired robustness level and 2) “sparse”, allowing modes such that at least one drug concentration is allowed to be zero. The number of the modes over which to apply the combination therapy algorithm can also be reduced.

FIG. 3(A) shows an example of a conservative piecewise linear approximation to a Hill function associated with a virus mutant antibody pairs.

A family of robustly stabilizing controllers was synthesized for a range of desired robustness levels. It was found that two different trimixes were predominant: one more frequent combination comprised of (45-46G54W, PGT128, 10-1074) antibodies was present for smaller robustness levels and another combination (PG16, 45-46G54W, PGT128) appeared in addition to the first one when the desired robustness was allowed to be larger, as shown in FIG. 3(B). Note that the mean IC50 for virus mutants listed in Table 2 is greatest for the PG16 mono therapy than any other single antibody.

In reference [1], a different antibody trimix (3BC176, PG16, 45-46G54W) also containing PG16 was suggested and experimentally shown to produce a decline in the initial viral load. However, a majority of mice in the experimental study had a viral rebound to the trimix pre-treatment levels, suggesting that in these cases, the virus had evolved mutations that were resistant to the trimix treatment. Further study showed that the evolved mutants had mutations found in the PG16 and 45-46G54W monotherapy groups. This may be suggest that the combination of PG16 and 45-46G54W with another antibody, although stabilizing, may not be robust enough to the type of perturbations witnessed in a biological setting.

The results of this example demonstrate that the combination therapy perform well when design parameters such as sparsity, limits on the magnitude of gains, and robustness guarantees are simultaneously considered in the stabilizing solutions to the combination therapy. Experimentally searching for these combinations is infeasible as the number of potential therapies and possible concentrations to consider in experiments is intractable. The ability to design and synthesize combination therapy controllers, as described in the examples, can be used to guide these experimental activities. As such, a family of controllers can be generated based on “design specifications” tailored to not only the viral or cellular composition of the disease, but to explore tradeoffs between number of therapies used (sparsity), therapy concentrations (magnitude of the gain) and ability to support pharmacokinetic fluctuations (robustness to perturbations) and subsequently verify these experimentally.

### Formulation of Combination Therapy for Treatment

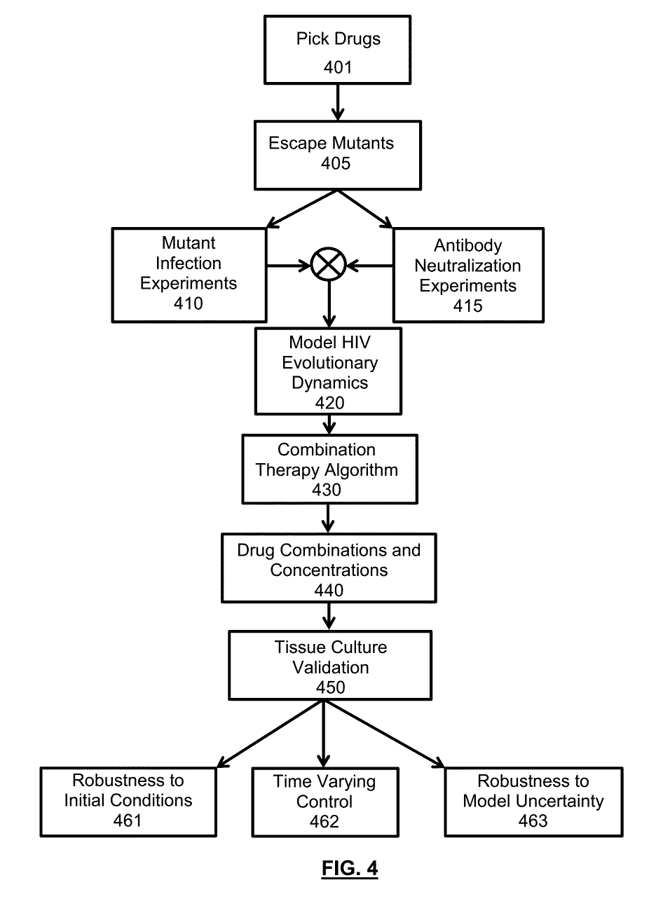

FIG. 4 shows a method for utilizing the combination therapy algorithms in creating effective combination drug treatments for a patent having HIV. First, a group of m antibodies (drugs) useful for treatment of HIV are selected 401 for consideration for the combination therapy. Then n escape mutants (mutants resistant to T-cell interaction) of the HIV present in the patient are selected 405 for neutralization. Mutant infection experiments 410 and antibody neutralization experiments 415 are carried out on the n mutants to determine parameters for the replication rates, degradation rates, and neutralization rates of the n mutants with respect to each of the m antibodies. These parameters are then used to create a quasispecies model 420 for evolutionary dynamics. A combination therapy algorithm 430 is then used to determine suboptimal or optimal combinations of concentrations 440 of the m drugs, with numbers of antibodies and concentrations of antibodies minimized. The combination therapy can then be tested 450 against a tissue culture for robustness against the initial conditions 461, time varying control 462, and robustness against uncertainty in the model 463. If the combination therapy is determined to be robust, it can then be applied to the patient.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventorinventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

### REFERENCES

[1] F. Klein, A. Halper-Stromberg, J. A. Horwitz, H. Gruell, J. F. Scheid, S. Bournazos, H. Mouquet, L. A. Spatz, R. Diskin, A. Abadir, et al., “HIV therapy by a combination of broadly neutralizing antibodies in humanized mic,” Nature, 2012.
[2] J. A. Horwitz, A. Halper-Stromberg, H. Mouquet, A. D. Gitlin, A. Tretiakova, T. R. Eisenreich, M. Malbec, S. Gravemann, et al., “Hiv1 suppression and durable control by combining single broadly neutralizing antibodies and antiretroviral drugs in humanized mice,” PNAS, 2013.

What is claimed is:

1. A method for creating a combinational drug therapy for HIV, comprising:
selecting a plurality of drugs, each of the plurality of drugs comprising at least one HIV escape mutant neutralizing antibody;
determining replication rates and degradation rates of a plurality of escape mutants of the HIV;
determining neutralization characteristics of each of the plurality of drugs;
creating an evolutionary dynamics model of the HIV based at least on the replication rates, the degradation rates, and the neutralization characteristics;
calculating dosages of each of the plurality of drugs using an iterative algorithm based on the evolutionary dynamics model, the algorithm including a Hill equation, wherein the dosages are non-negative real values;
creating a combinational drug therapy based on the dosages.

2. The method of claim 1, wherein the iterative algorithm is an 3-C,, state feedback synthesis algorithm.

3. The method of claim 1, wherein the iterative algorithm is a second order cone program algorithm.

4. The method of claim 3, wherein the iterative algorithm takes into account non-linear pharmodynamics of the drugs.

5. The method of claim 1, wherein the iterative algorithm is a convex-monotone algorithm.

6. The method of claim 5, wherein the iterative algorithm includes time-varying drug dosages.
